(19) United States
(12) Patent Application Publication
(10) Pub. No.: US 2004/0131453 A1
(43) Pub. Date: Jul. 8, 2004

(54) Rapidly collapsible multi-cellular mobile accommodation assembly

(76) Inventor: Franc Birtic, Dobrova (SI)

Correspondence Address: Richard R Ruble, Jackson Walker, Suite 1900, 1401 McKinney Street, Houston, TX, 77010, US

(21) Appl. No.: 10/472,267

(22) PCT Filed: Dec. 20, 2001
(86) PCT No.: PCT/SI01/00037

(30) Foreign Application Priority Data
Apr. 12, 2001 (SI) P-200100101

(51) Int. Cl. B60B 29/00

(52) U.S. Cl. 414/426

(57) ABSTRACT

A rapidly collapsible multi-cellular mobile accommodation assembly comprises several accommodation units (21, 22, 23, 24, 25), which can be placed within a container (1) and transported by means of a vehicle (3) to any desired location and then in-situ positioned, built-up and prepared for comfortable accommodation. This is generally achieved in such a way, that several collapsible accommodation units (21, 22, 23, 24, 25) are placed in their collapsed state within a container (1), preferably a truck container, and are removable therefrom by means of translation movement. The said units (21, 22, 23, 24, 25) and if desired also a sanitary unit (21′) are equipped with necessary installations.

The present invention relates to a rapidly collapsible multi-cellular mobile accommodation assembly comprising several accommodation units which can be transported to any desired location and which can be then in-situ positioned in appropriate manner, built-up and prepared for comfortable accommodation, namely for accommodation/residing and especially also for performing serious team-work supported by modern technical and telecommunication equipment.

The invention is based on the problem, how to conceive an assembly of accomodation units, by which several units, e.g. at least three or even five of them should be simultaneously transportable by means of an appropriate land vehicle even along the path-less terrain, but whenever required the units should be also either separately or in groups transported to the heavy accessible locations (i.e. locations which may be absolutely inaccessible by ordinary trucks), by means of land vehicles or aircrafts or by means of any other means intended for transport by water, whereupon after delivery, the units should be arranged in each appropriate manner with respect to the actual purpose and rapidly set-up in order to prepare them for comfortable accommodation and performing appropriate activities, and where each of the said units should be already pre-equipped in such a manner that it may be used for certain purpose in various weather conditions not only with respect to comfortable accommodation but also with respect to working conditions which have to be fulfilled when using modern technical and telecommunication equipment as may e.g. be used by military groups or by life-saving groups in the case of natural catastrophes or by other working groups which have to work in situ. Vehicles, which at the one hand enable mobility and on the other hand accommodation, are known from various written sources, among others also from the patent documents. Numerous known solutions also relate to the problem of enlarging accommodation area, which can be solved in various ways.

In EP 0 187 430 there is described a motor vehicle, by which the car trunk as available in the rear part of the vehicle may be extended by means of an additional accommodation unit which might be simply described as a kind of a tent; in such a manner at least sleeping in the car can be enabled, if not complete temporary accommodation. However, such enlargement of the accommodation area is essentially small, and any solution of this kind is practically irrelevant with respect to solving the problem as defined in connection with the present invention.

Furthermore, a camping trailer is described in EP 0 317 029, which is in fact a light trailer intended for coupling to personal vehicles and comprises a platform, which can be after disconnection from the vehicle pulled forwards in order to establish a flat accommodation surface which is elevated with respect to the ground and which is in the top view about two times greater as the normal bottom surface of the trailer as such. In addition, the trailer comprises movable frames, which may be pivoted in the longitudinal direction of the trailer and then fixed in a fan-shaped arrangement in order to cover them by a tent. The whole bottom surface, which is at least declaratively protected with respect to the weather conditions, in such built-up state corresponds to approximately triple ordinary bottom surface of the trailer. However, it is commonly difficult to move such trailer along the pathless terrain. In its built-up state, the trailer enables attractive accommodation, which may approximately correspond to accommodation under a tent. This means that such trailer may serve for holidays purposes, but is at the same time quite useless with respect to performing serious team-work supported by modern technical and telecommunication equipment.

WO 88/00141 describes a collapsible camper comprising a platform, to which several frames may be attached, which consist of tubes and rods and over which a tend may be put. Such unit may be transported anywhere, even to difficult accessible places and even by means of military or similar vehicles along the pathless terrain. However, conditions of accommodation still correspond to those as by accommodation under a tent and are therefore quite useless with respect to purposes, achieving of which is required by the present invention.

Still further, in WO 96/30229 a mobile accommodation unit is described, which is in fact a kind of camper having on its rear part a rigid back wall and sidewalls which may be pivoted outwards. Upon pivoting the said sidewalls for approx. 45 grads outwardly, between the sidewalls and the back wall two telescopic, in the top view circularly shaped panels are formed. In such way, the bottom surface may be achieved in form of mushroom which is maybe two-times greater than the bottom surface in the collapsed state including the drivers working place, i.e. cockpit. By means of such vehicle, especially in a heavy-duty version, the accommodation unit may be transported even to various difficultly accessible places or even along the pathless terrain. It is however difficult to believe, that the dimensions of the available place including geometrically irregular shape might in parallel to tolerable accommodation also enable serious team-work supported by modern technical and telecommunication equipment.

Still another camping trailer is described in WO 98/21067, which is intended for attaching a tend at the one side thereof. Such trailer may offer accommodation of the expected quality in various weather conditions, and may at the same time be equipped with installations as required by establishing conditions for serious team-work supported by modern technical and telecommunication equipment. However, the trailer as such is not comfortable with respect to its agility and is difficultly transportable to difficult accessible places along e.g. purely maintained roads or even mountain roads or along the pathless terrain. Dimensions of such trailer, which may be therefore transported exclusively along well-maintained roads, allow sleeping and provisional accommodation incl. preparing of food, while e.g. serious team-work supported by modern technical and telecommunication equipment cannot be ensured. Indeed, the extended surface means certain enlargement of the bottom surface and also the volume of the accommodation space, but the quality of such extended space in fact corresponds to those under a tend, which obviously does not enable serious team-work supported by modern technical and telecommunication equipment.

EP 0 251 957 refers to a trailer, by which dimensions of its bottom surface correspond to dimensions of an ordinary camping trailer. When ready for transporting, the trailer is relatively low, with respect to a drawing id should not exceed about a third of the height of an ordinary camping trailer. Accordingly, the trailer might offer excellent agility and stability and also visibility from the towing vehicle in the rearwards direction. Thanks to the possibility of the telescopic expansion of the accommodation space for about three times in comparison with the original space and by unchanged bottom surface, the trailer may be declared as very comfortable for accommodation regardless to the weather conditions, but not also for performing a serious team-work supported by modern technical and telecommunication equipment, as mentioned several time before.

Still further, a mobile unit is described in WO 99/65731 which is in fact a trailer or a vehicle equipped by wheels. The mobile unit comprises hard walls, and the sidewalls include pivotable panels, which are attached to the fixed walls by means of hinges and may be pivoted away in order to enlarge the volume of the accommodation place. As far as the vehicle is foreseen for transporting by road, its width is limited o the basis of relevant rules. Assuming that on each side just one additional accommodation unit should be established, at least four pivotable panels have to be placed in the area of each sidewall, i.e. the front one, the back one, the outward longitudinal panel and the bottom panel, while in the top there have to be available two covering plates, each of them has to be arranged pivotably in the corresponding direction. In fact, an extension of the accommodation space may be achieved which corresponds to a double bottom surface, and moreover, the accommodation or working chambers are arranged together and cannot be re-arranged with respect to each given situation. Due to attaching the sidewalls onto the vehicle it might also happen that according to opinion of the present applicant, the vehicle could be very heavy or even instable with respect to requirements related to transporting along the pathless terrain.

Analogous solution is described in WO 99/3368, where the vehicle is also equipped with hard walls, by which at least one sidewall may be pulled-out in the transversal direction in order to expand the accommodation space. The problems related thereto are essentially the same as by the previously described solution.

Still another trailer is described in WO 84/00331, which comprises two units, which may be pulled-out in the transversal direction and equipped by beds. Such unit may also enable enjoying holidays or a short-term residing e.g. in case of a disaster even in various weather conditions, but is quite useless for serious team-work supported by modern technical and telecommunication equipment.

Quite similarly, EP 0 126 293 relates to a trailer having two units, which may be pulled-out, the front one in the forward direction, and the back one in the rearward direction. This solution also enables establishing approximately two-times larger bottom surface as well as the volume of the accommodation space, but is unfortunately useless with respect to driving along the pathless terrain and commonly also for enabling serious team-work supported by modern technical and telecommunication equipment.

Finally, a multi-purpose mobile accommodation unit is described in WO 93/00231, which consists of four separate chambers, which may be entered from the central area of the accommodation unit. Dimensions of the accommodation unit are probably determined in accordance with the rules related to driving on the roads, and each of the said chambers may be expanded by its pulling-out in the transversal direction. The bottom surface and the volume correspond approximately to two-times enlarged top-surface and volume, respectively, of the trailer as such. The trailer cannot be towed along the pathless terrain, and arrangement of the said chambers cannot be changed anyway. It is therefore obvious, that such trailer cannot be transported to difficult accessible places at all.

Rapidly collapsible accommodation assembly according to invention essentially relates to a plurality of variously arranged and configured accommodation units, and as a matter of fact consists of containers, preferably truck containers, which may be transported by means of vehicles, especially military or similar vehicles or even by means of appropriate helicopters, by which each of the said containers comprises several rapidly collapsible accommodation units of generally equal bottom surface and height, which may in common be foreseen for various purposes and use. Such accommodation units, placed within the abovementioned container, may be then transported by means of appropriate vehicle along the raw cart-ways or even along the pathless terrain to certain location, and then on this place either rapidly built-up and arranged for accommodation and serious work in various weather conditions, or also separately one by one transported e.g. by means of small helicopters to any desired difficult accessible or practically inaccessible locations and then built-up in such place. Accommodation units contained in each single container enable establishing at least approximately four times, and preferably even five times larger bottom surface and volume than the bottom surface or the volume, respectively, of the container as such, by which moreover the accommodation units may be arranged in various ways during/after building them up. In addition, a sanitary unit is foreseen, which includes sanitary equipment as well as the place and requisites intended for washing and showering. Furthermore, accommodation units are foreseen, which are equipped by complete installations, by means of which the units may be assembled in form of a military headquarters equipped by complete technical, computer, navigation and telecommunication support. Still further possible configuration of the accommodation units arranged one adjacent to another on the desired location, enable forming a conference room or a teaching cabinet. A rapidly collapsible multi-cellular mobile accommodation assembly comprises several collapsible accommodation and/or sanitary units, which are placed each above another in their collapsed state within a container which, especially a truck container, and are supported by guides arranged within the container, especially on the inside walls. The said container is preferably equipped by telescopic supporting legs operated by means of either hand-driven or electrically operated hydraulic assembly, and which units are removable there-from by means of translation movement and may be assembled in-situ thereupon. By this, several accommodation and/or sanitary units are placed within the container, preferably a truck container, each above another, and the said units may be pulled-out by means of translation movement and after that assembled in-situ, and by which each of the accommodation units consists of a bottom panel, to which two transversal wall panels optionally equipped by windows and doors as well as two longitudinal wall panels optionally equipped by windows and doors are pivotably attached, over which a ceiling panel is placed. By one of possible embodiments of the invention, within the container, which is conceived as a truck container and equipped by telescopic supporting legs operated by means of either hand-driven or electrically operated hydraulic assembly, simultaneously with the sanitary unit which comprises required sanitary and toilet and bathroom equipment and which may be removed there-from and rapidly assembled in-situ, also at least two accommodation units are available, by which each of the accommodation units consist of a bottom panel, to which two transversal wall panels optionally equipped by windows and doors as well as by two longitudinal wall panels optionally equipped by windows and doors are pivotably attached, over which a ceiling panel is placed A flier embodiment of the invention is character by that, within the container, which is conceived as a truck container and upped by telescopic supporting legs operated by means of either hand-driven or electrically operated hydraulic assembly, at least three accommodation units are available, by which each of the accommodation units consists of a bottom panel, to which two transversal wall panels optionally equipped by windows and doors as well as two longitudinal wall panels optionally equipped by windows and doors are pivotably attached, over which a ceiling panel is placed. The most preferable embodiment of the present invention is characterized in that within the container, which is conceived as a truck container and equipped by telescopic supporting legs operated by means of either hand-driven or electrically operated hydraulic assembly, five accommodation units are available, by which each of the accommodation units consists of a bottom panel, to which two transversal wall panels optionally equipped by windows and doors as well as two longitudinal wall panels optionally equipped by windows and doors are pivotably attached, over which a ceiling panel is placed. Furthermore, the accommodation assembly according to the invention comprises a hydraulic assembly, by means of which telescopic supporting legs are moved, by this, the said hydraulic assembly is preferably electrically driven, but if desired also hand-operated, and is conceived in such manner that the said legs are movable towards the ground separately and independently each from another, so that moving of each leg is stopped as soon as the contact is established between the leg and the ground, while moving of other legs is continued until all the legs either simultaneously or separately are brought into contact with the ground. Another feature of the present invention is, that the accommodation units and if desired also the sanitary unit are mobile and transportable by means of land-vehicle or by means of any desired means for locomotion by water or by appropriate aircraft either simultaneously within a container or separately. Still another feature of the present invention is, that the accommodation units and if desired also the sanitary unit, may be assembled on each desired location either as single units or as combined/complex accommodation units. Finally, the accommodation units and if desired also the sanitary unit, are equipped with necessary installations, especially electric installations, connecting means and switching means, and may be set-up in-situ by pivotable disposition both transversal wall panels optionally equipped by windows and doors as well as of two longitudinal wall panels also optionally equipped by windows and doors away from the bottom panel, and by covering them by means of the ceiling panel.

An embodiment of the assembly according to the invention will be described in more detail on the basis of the attached drawing, where

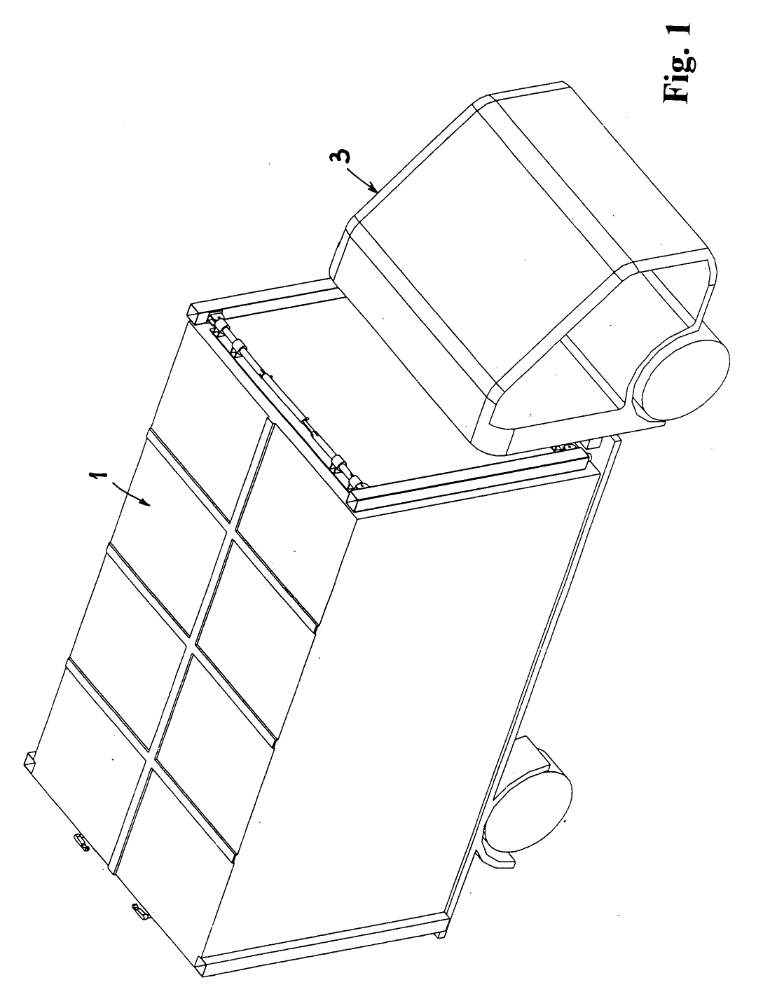

FIG. 1 illustrates a perspective view of a rapidly collapsible multi-cellular mobile accommodation assembly during transport by means of a land-vehicle;

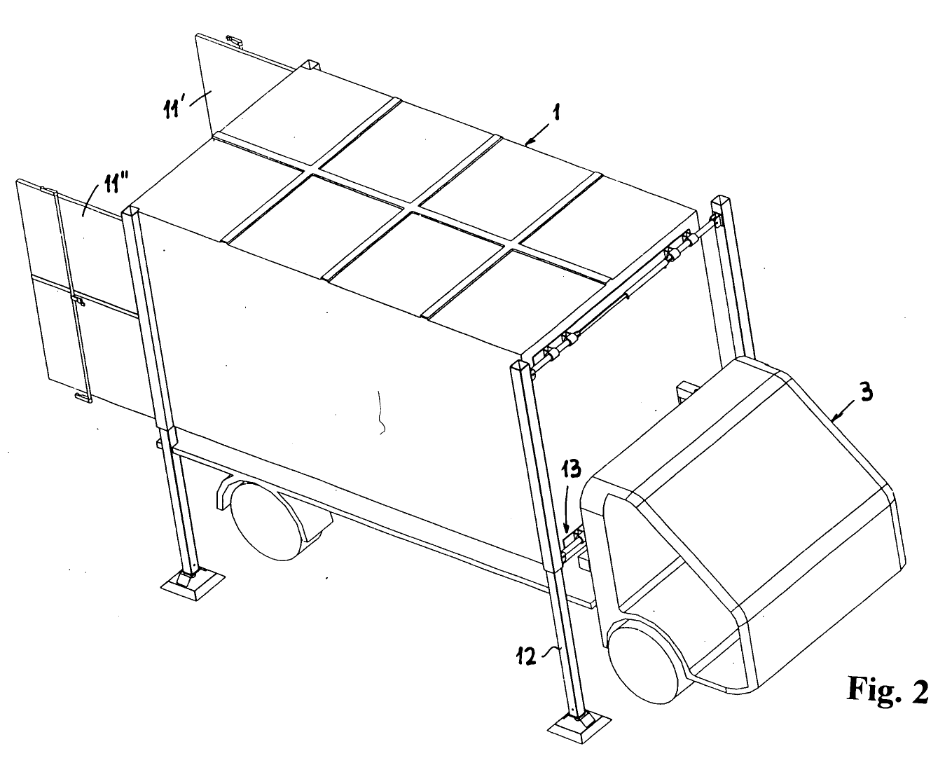

FIG. 2 illustrates a rapidly collapsible multi-cellular mobile accommodation assembly just before its unlading, in perspective front view;

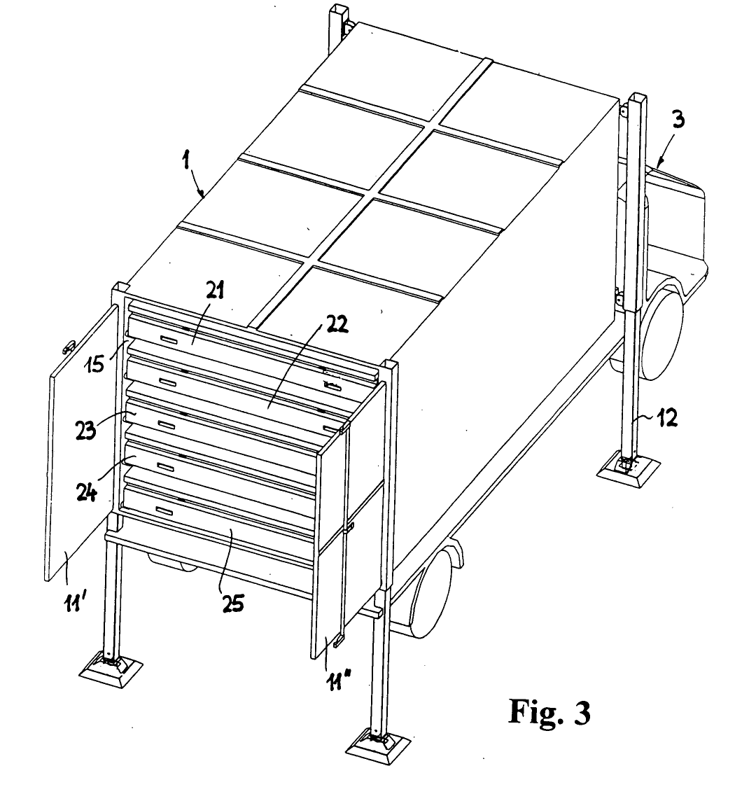

FIG. 3 illustrates a rapidly collapsible multi-cellular mobile accommodation assembly just before its unlading, in perspective rear view;

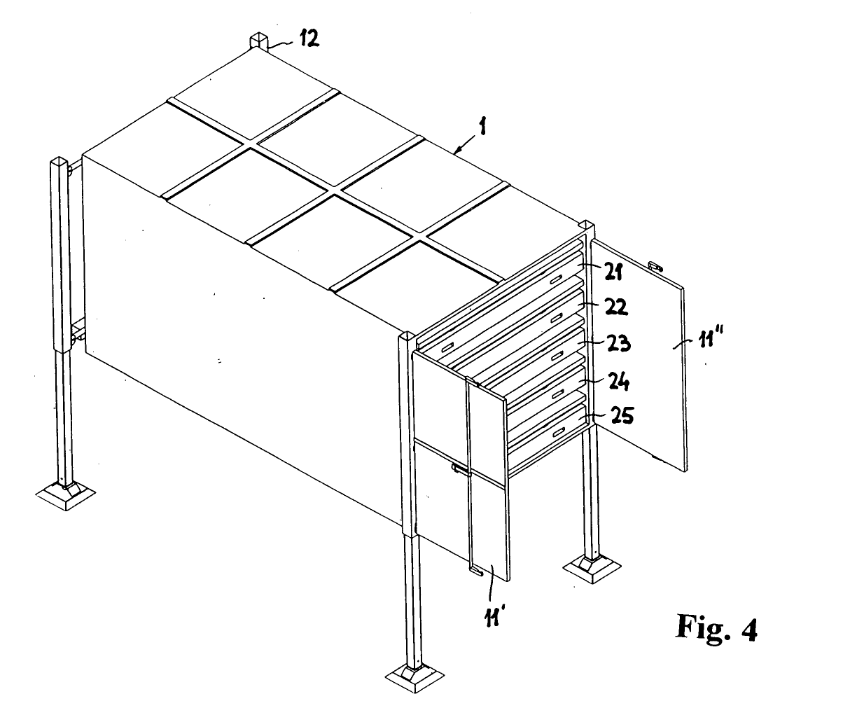

FIG. 4 illustrates unladed rapidly collapsible multi-cellular mobile accommodation assembly, in perspective rear view;

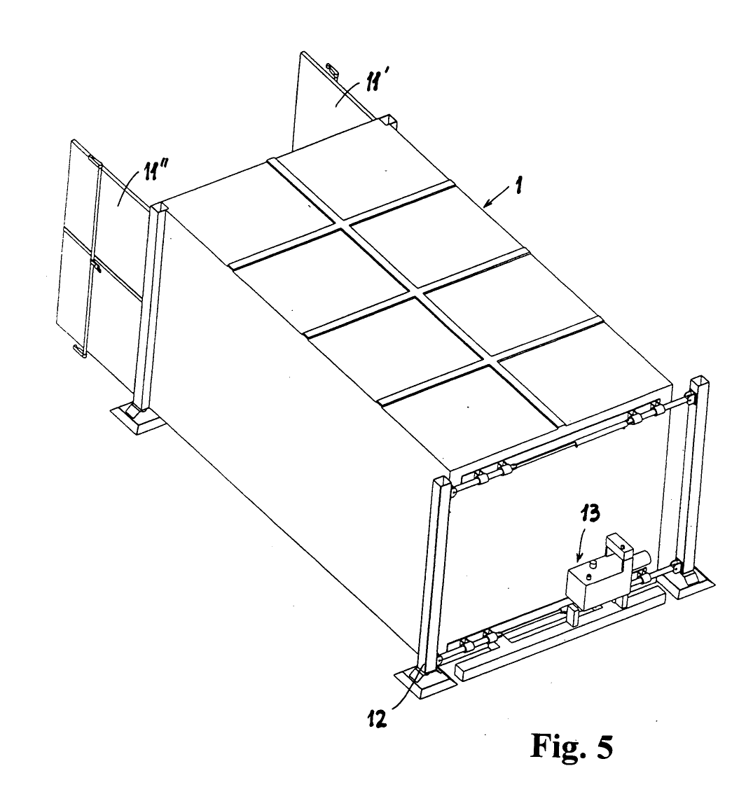

FIG. 5 illustrates a rapidly collapsible multi-cellular mobile accommodation assembly just before pulling-out the particular accommodation units, in perspective front view;

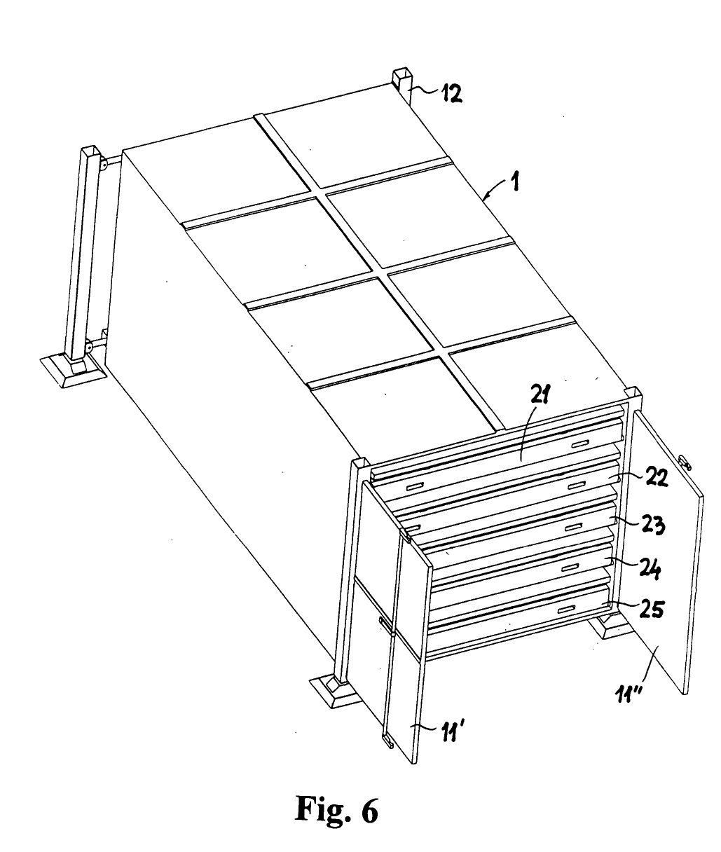

FIG. 6 illustrates a rapidly collapsible multi-cellular mobile accommodation assembly just before pulling-out the particular accommodation units, in perspective rear view;

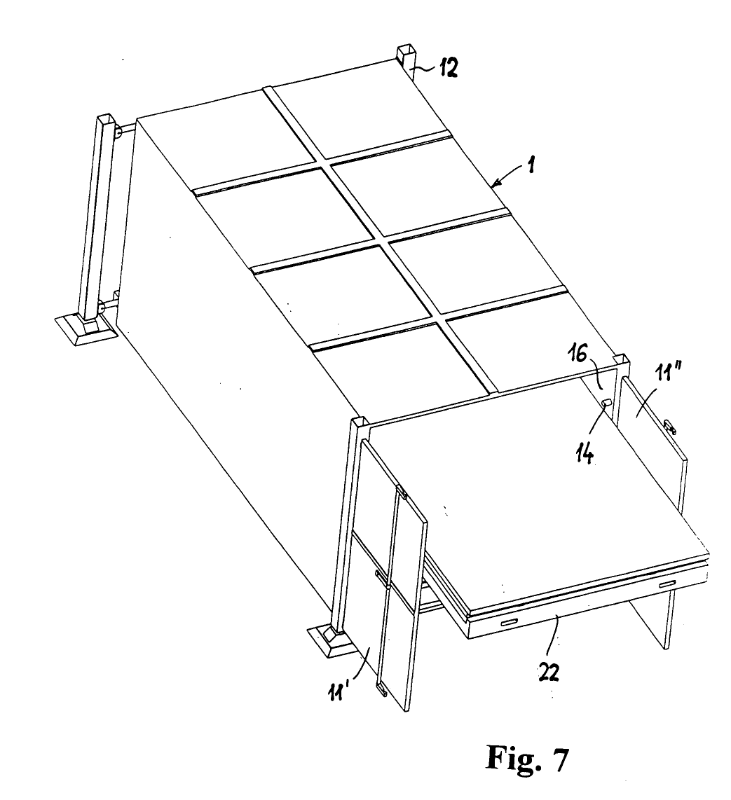

FIG. 7 illustrates a rapidly collapsible multi-cellular mobile accommodation assembly where one of the accommodation units is already partially pulled-out, again in perspective rear view;

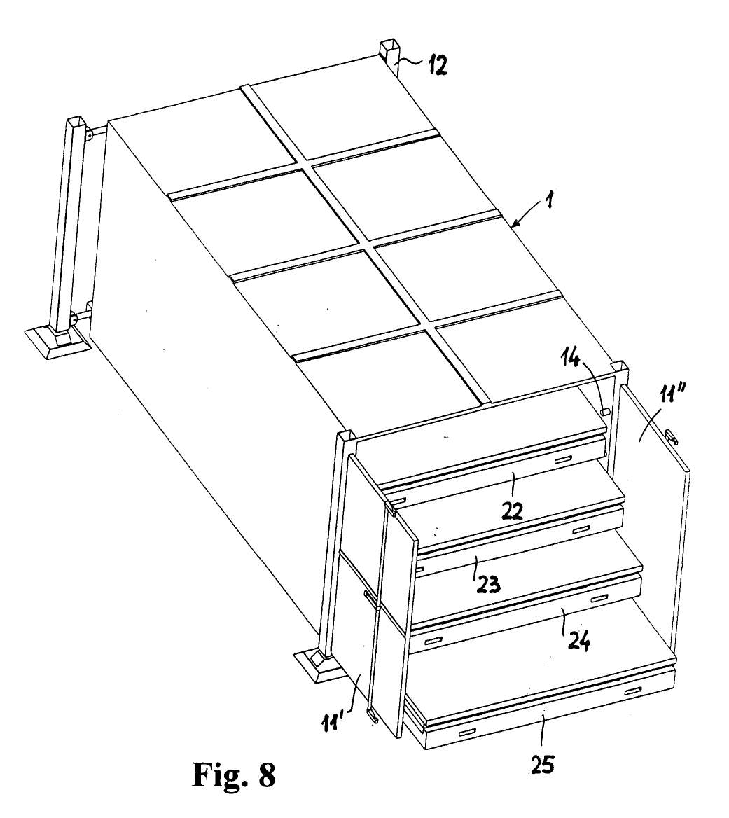

FIG. 8 illustrates a rapidly collapsible multi-cellular mobile accommodation assembly having accommodation units partially pulled-out, again in perspective rear view;

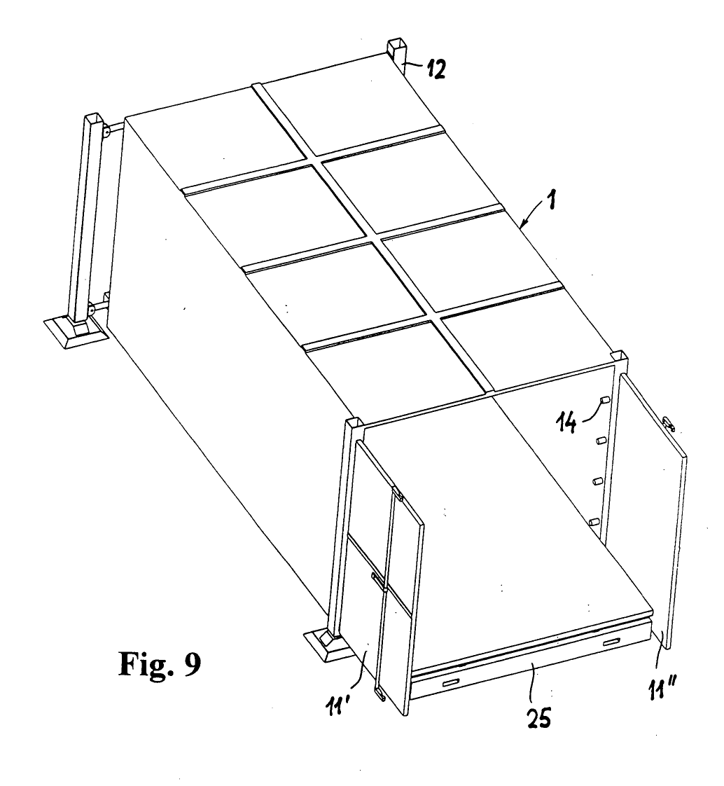

FIG. 9 illustrates a rapidly collapsible multi-cellular mobile accommodation assembly after removing majority of accommodation units and with partially pulled-out the rest accommodation unit, again in perspective rear view;

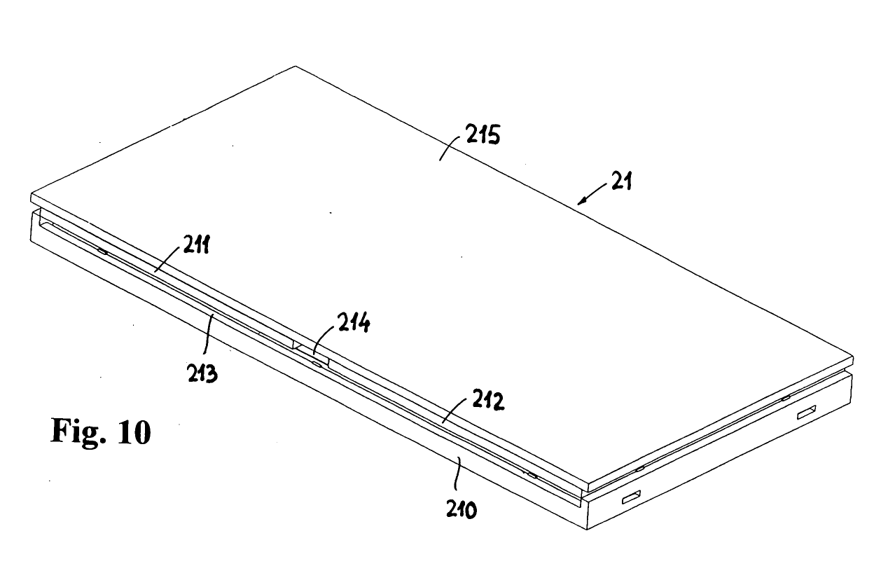

FIG. 10 illustrates one of the accommodation units in the collapsed/folded state, in perspective view;

FIG. 11 illustrates the accommodation unit according to FIG. 10 after removing the ceiling panel, in perspective view;

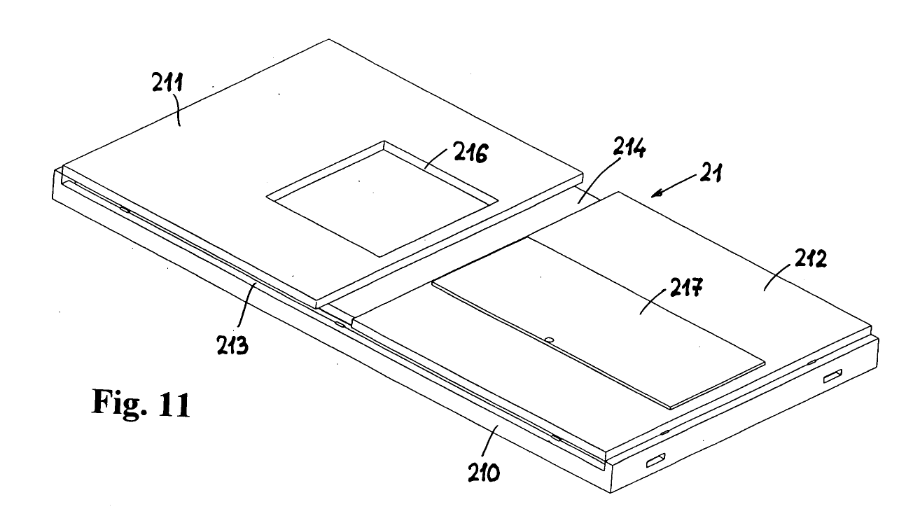

FIG. 12 illustrates the accommodation unit according to FIG. 10 during assembling thereof, namely by lifting the ceiling panel, in perspective view again;

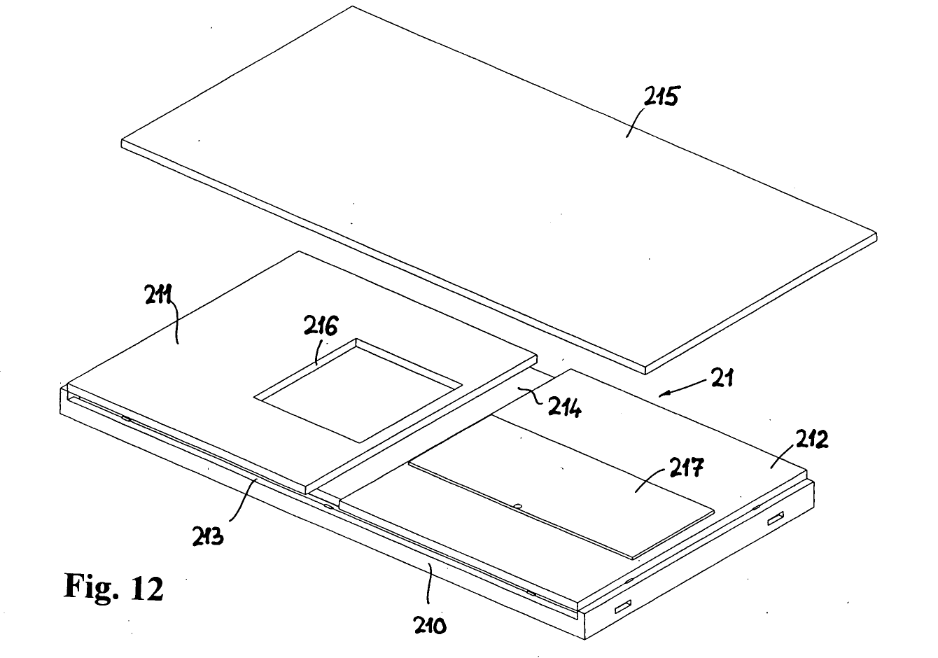

FIG. 13 illustrates the unit according to FIG. 10 during its assembling, namely during re-positioning one of the pivotable transversal wall panels when the ceiling panel is lifted, in perspective view;

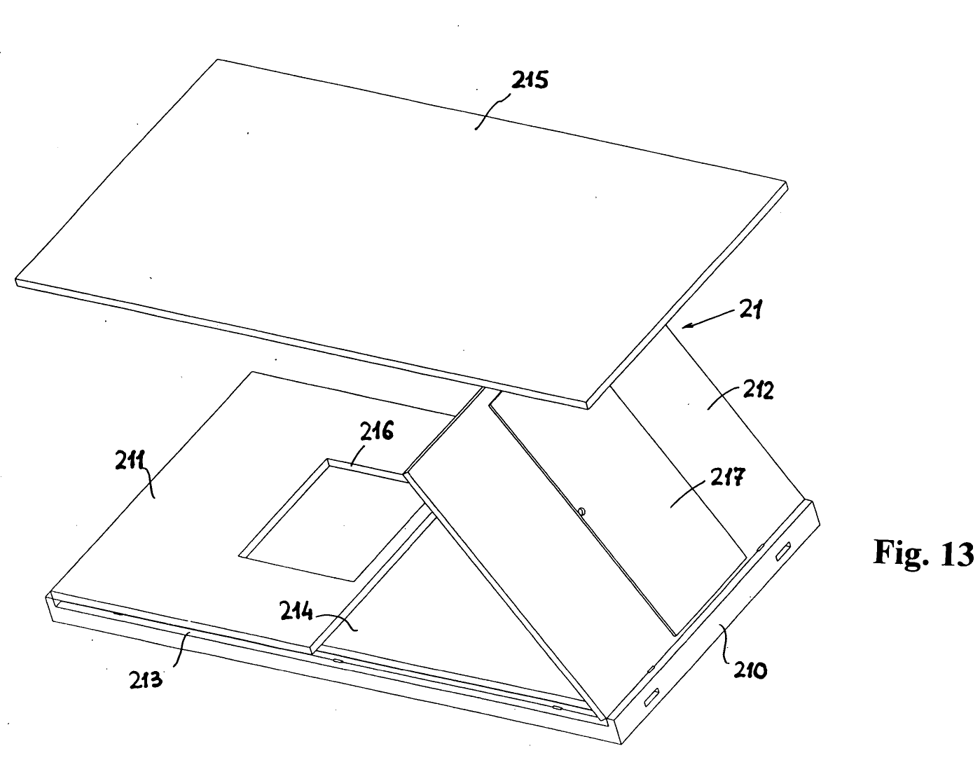

FIG. 14 illustrates the unit according to FIG. 10 during its assembling, namely during re-positioning the other of the pivotable transversal wall panels when the ceiling panel is lifted, in perspective view;

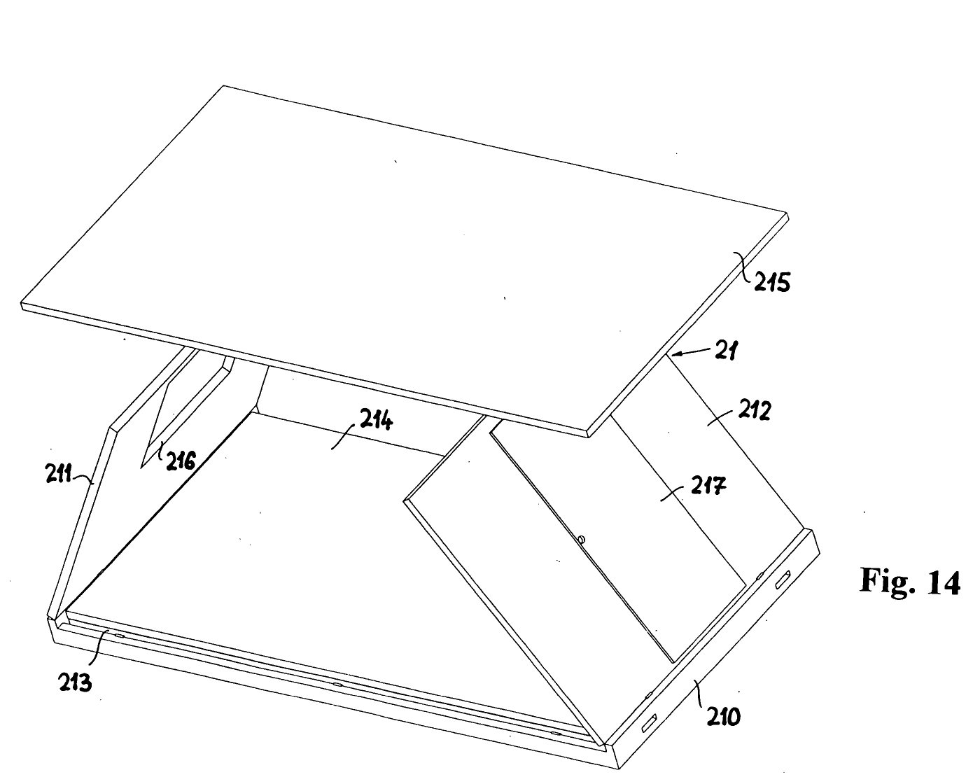

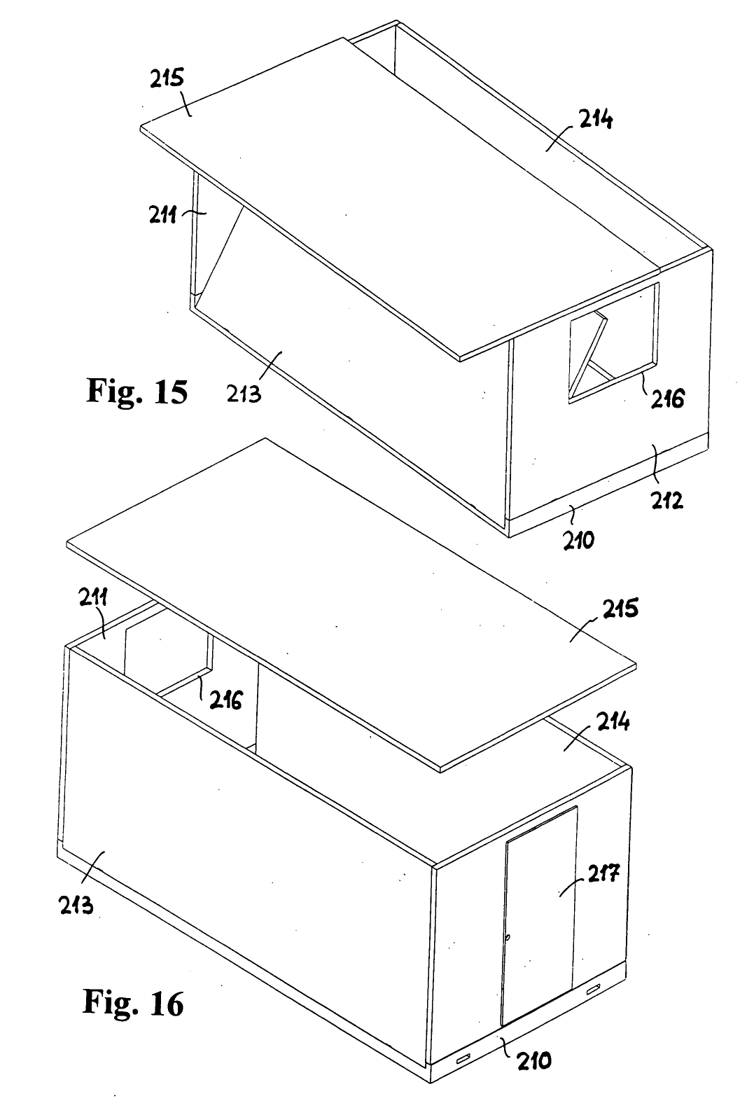

FIG. 15 illustrates the accommodation unit according to FIG. 10 during its assembling, namely during re-positioning one of the pivotable longitudinal wall panels when the ceiling panel is partially set-up, in perspective view;

FIG. 16 illustrates the accommodation unit according to FIG. 10 during its assembling, i.e. setting-up the ceiling panel, in perspective view;

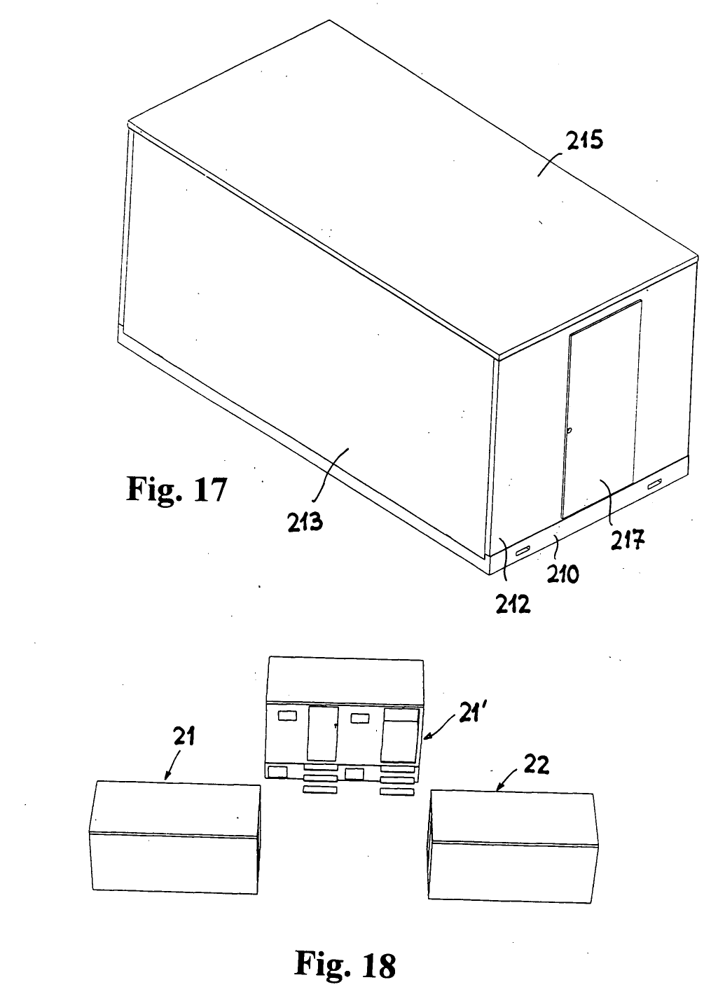

FIG. 17 illustrates the assembled accommodation unit according to FIG. 10 in perspective view;

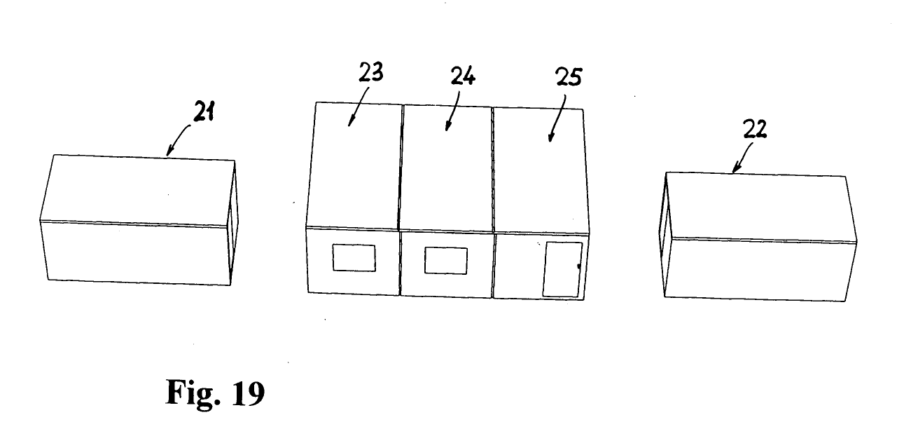

FIG. 18 illustrates one of various possible embodiments of a rapidly collapsible multi-cellular mobile accommodation assembly, consisting of two accommodation units and a sanitary unit, which may be simultaneously transported by means of a single land-vehicle as shown in the FIG. 1.

FIG. 19 illustrates another embodiment of a rapidly collapsible multi-cellular mobile accommodation assembly, which consists of five accommodation units, and three of them may be assembled into a complex accommodation unit, where all five units can be simultaneously transported by means of a single land-vehicle as shown in the FIG. 1; and

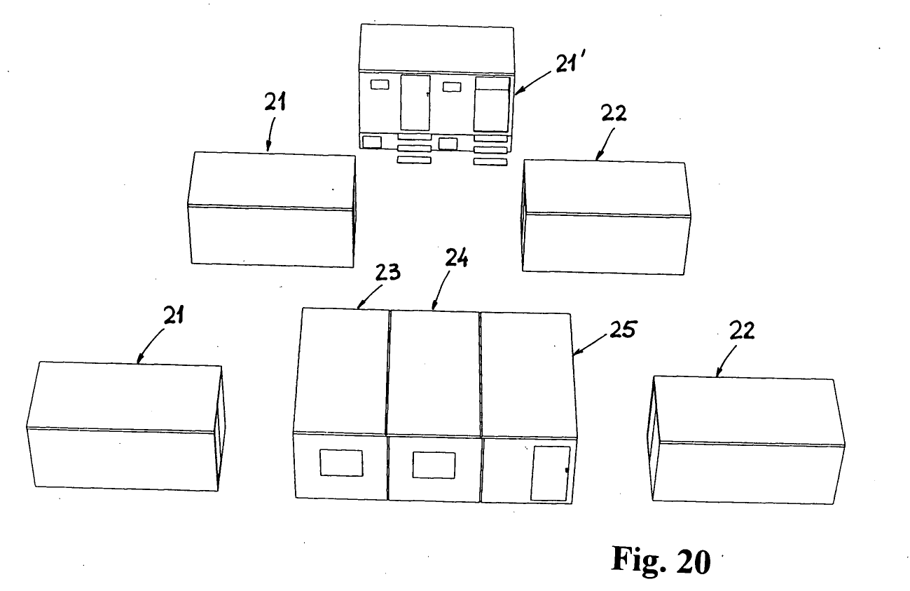

FIG. 20 illustrates a combination of possible embodiments of a rapidly collapsible multi-cellular mobile accommodation assembly according to FIGS. 18 and 19, which consists of seven accommodation units, from which three are assembled into a complex accommodation unit, as well as of a sanitary unit, by which all these seven units may be simultaneously transported e.g. by means of just two land-vehicles as shown in the FIG. 1.

A rapidly collapsible multi-cellular mobile accommodation assembly according to the invention consists of a container 1, which is preferably available as a truck container and into which several accommodation units 21, 22, 23, 24, 25 in their folded/collapsed state may be placed.

Dimensions of the container 1 should not exceed or should be even less than dimensions of containers used by ordinary road-lorries, which makes transport on bad roads or even on the path-less terrain much easier and essentially improves manoeuvering performances of the vehicle. For example, the width of a container 1 foreseen for transport by means of a military land-vehicle 1 (especially a truck) as shown in FIG. 1, may be approx. 2.4 m, the height may be approx. 2.3 m, and the length may be approx. 4.5 m. Those skilled in the art should understand that a container loaded onto a military or similar land-vehicle may be transported along the mountain roads or forest roads or even along the path-less terrain without essential difficulties.

Furthermore, the container 1 rearwards equipped by a door 11′, 11″, and is moreover also equipped by telescopic supporting legs 12. By the shown embodiment, four telescopic legs are foreseen, which can be moved (shortened, extended) by means of an appropriate hydraulic assembly 13. Hydraulic assembly may be either hand-operated or—whenever possible—driven by means of an appropriate electric driving unit, which is not separately shown in the attached drawing and which preferably operates under the same electric conditions as the vehicle itself. Each of the said telescopic legs 12 of the container comprises a hydraulic cylinder, which is also separately not shown, and which is incorporated into appropriate hydraulic circuit of the said hydraulic assembly, preferably in such a manner that during unlading/removing the container 1 from the vehicle 3 each leg 12 due to operating the hydraulic assembly starts to move towards the ground and its movement is stopped as soon as the contact with the ground is established, while the movement of the other legs 12 is continued until all of them are successively brought into contact with the ground. Whenever the vehicle 3 is placed in at least essentially horizontal position, on the basis of such concept of the hydraulic assembly 13 and the hydraulic supporting legs 12 the whole container 1 even on relatively non-linear ground may therefore also be placed into at least approximately horizontal position.

Accordingly, the container 1 may be transported by means of appropriate vehicle 3 (FIG. 1) to each desired location, e.g. to military training or combat locations, to the area where a natural catastrophe has happened or similar. In such cases, thanks to the said hydraulic assembly 13, after arriving to certain location foreseen for placing the accommodation units 21, 22, 23, 24, 25, first of all the legs 12 are activated unless each of them is brought in contact with the ground (FIG. 2), by which appropriate support of the container 1 is ensured, and moreover also its positioning in at least essentially horizontal position. After some further lifting the container 1, e.g. by extending all the legs 12 for the same length (FIG. 4), the vehicle 3 can be moved away from below the container 1. After that, the container 1 may be dropped towards to the ground (FIGS. 5 to 9). When the door 11′, 11″ is opened, access to the units 21, 22, 23, 24, 25 is enabled, which are placed within the container 1 in its folded/collapsed state, and each of them is supported by appropriate guide 14 arranged in appropriate manner inside of the container 1 or more precisely on its inner walls 15, 16.

Quite in common, two kinds of embodiments of the units should be observed, where the units 21, 22, 23, 24, 25 are the accommodation units or working units, while the unit 21′ is the so called sanitary unit (FIG. 18). The sanitary unit 21 is equipped by appropriate water-supply, sewage and/or drainage installations and similar, as well as by toilet shells, washing installations, showers and similar fittings which are not separately shown in the enclosed drawing. For sufficient understanding the present invention, the attention should be drawn to the fact, that the dimensions of the sanitary unit 21′, especially its width and its length, correspond to those of the other accommodation units 21, 22, 23, 24, 25 and may moreover be stored within the container 1 in the same manner, with a single exception, that its height or thickness may be essentially greater as by other accommodation units 21, 22, 23, 24, 25, since various sanitary equipment has to be incorporated therein.

In common, into each container 1 having the before mentioned dimensions 2.4×4.5×2.3 m either five accommodation units 21, 22, 23, 24, 25 may be placed, each having a width 2.25 m, a length 4.41 m, and a height (in folded/collapsed state) less than 0.3 m, or whenever the presence of the sanitary unit 21′ is required, into each container 1 at least two of the accommodation units 21, 22, 23, 24, 25 may be placed together with a sanitary unit 21′.

By means of each of the accommodation units 21, 22, 23, 24, 25, the accommodation area of approx. 10 m² is available, which naturally means that by means of just a single vehicle 3 either approx. 50 m² of the accommodation and/or working place or at least approx. 20 m² or 30 m² accommodation and/or working place plus approx 10 m² sanitary place can be ensured in a very short time even on a practically inaccessible location, by which the accommodation and/or working place may be explored either in form of separated rooms/cells or by combining and assembling units 21, 22, 23, 24, 25 even in form of complex accommodation and/or working units having the bottom surface of approx. 20, 30, 40, 50 m² or even more, as shown e.g. in the FIGS. 18 to 20.

Each accommodation unit 21, 22, 23, 24, 25 comprises a platform or a bottom panel 210, to which two opposite arranged transversal panels 211, 212 and moreover two opposite arranged longitudinal panels 213, 214 are pivotably attached, over which in the set-up state the ceiling panel 215 is placed. All the said constituent parts are made of light, rigid and warm insulating materials for example in form of the so-called sandwich plates consisting of two sheets of aluminium and a layer of polyurethane foam placed there-between. If desired, all the aforementioned constituent parts are equipped by various windows 216 and doors 217 and moreover also by appropriate electric installations (not shown) enabling connection to available electric-supply systems, when available. Moreover, when desired, the accommodation units 21, 22, 23, 24, 25 may be placed onto additional platforms or stands which are not separately illustrated in the drawing and which may be equipped by telescopic legs in order to ensure adjusting units 21, 22, 23, 24, 25 into the horizontal position; furthermore the units may be equipped by air-conditioning appliances and similar installations in order to enable comfortable accommodation and working, which is in fact the reason for transporting the units onto the certain place.

In order to illustrate the use of the invention it should be furthermore exposed that a group of 6 to 8 skilled men should be capable to build-up a complete settlement of accommodation units 21, 22, 23, 24, 25 and a sanitary unit 21′ (as e.g. those in FIG. 1) within less than two hours. Furthermore, a unit 21 can be easily transported by air even by means of a small helicopter. In the case of natural catastrophe, e.g. an earth-quake, avalanches or similar, certain number of containers 1 can be transported to the location of the catastrophe or to the surrounding by means of the vehicles 3, and then to build-up the settling of numerous accommodation units 21, 22, 23, 24, 25 including the sanitary units 21′; at the same time, some units 21, 22, 23, 24, 25 may also be transported by helicopter to some other locations on various altitudes in order to ensure observation, organization etc. Whenever the containers 1 and 21, 22, 23, 24, 25 including sanitary units 21′ are used for military purposes, they can be efficiently hidden in the same manner as e.g. the vehicles by means of masking coverings or nets which are also not shown in the enclosed drawing.

1. Rapidly collapsible multi-cellular mobile accomodation assembly, comprising several collapsible accomodation units (21, 22, 23, 24, 25; 21′), which are placed in their collapsed state within a container (1), especially a truck container, and are removable there-from by means of translation movement in order to be assembled in situ after that, characterized in that the units (21, 22, 23, 24, 25; 21′) are arranged within a container (1) each above another, and each of them is supported by appropriate guides (14) arranged within the container (1).

2. Rapidly collapsible multi-cellular mobile accomodation assembly according to claim 1, characterized in that the units (21, 22, 23, 24, 25; 21) are supported by appropriate guides (14) arranged on the inner walls (15, 16) of the container (1).

3. Rapidly collapsible multi-cellular mobile accommodation assembly according to claim 1 or 2, characterize in that several accommodation and/or sanitary units (21, 22, 23, 24, 25; 21′) are placed within the container (1) each above another, the said units may be removed by translation and assembled in-situ after that, by which each of the accommodation units (21, 22, 23, 24, 25) consists of a bottom panel (210), to which two transversal wall panels (211, 212) optionally equipped by windows (216) and doors (217) as well as two longitudinal wall panels (212, 214) optionally equipped by windows (216) and doors (217) are pivotably attached, over which a ceiling panel (215) is placed.

4. Rapidly collapsible multi-cellular mobile accommodation assembly according to claim 1 or 2, characterized in that within the container (1), which is operated by means of either hand-driven or electrically operated hydraulic assembly (13), several accommodation units (21, 22, 23, 24, 25) and optionally a sanitary unit (21) are placed, which may be removed there-from and rapidly assembled in-situ, by which each of the accommodation units (21, 22, 23, 24, 25) consists of a bottom panel (210), to which two transversal wall panels (211, 212) optionally equipped by windows (216) and doors (217) as well as two longitudinal wall panels (212, 214) optionally equipped by windows (216) and doors (217) are pivotably attached, over which a ceiling panel (215) is placed.

5. Accommodation assembly according to claim 3, characterized in that within the container (1), which is conceived as a truck container and equipped by telescopic supporting legs (12) operated by means of either hand-driven or electrically operated hydraulic assembly (13), simultaneously with the sanitary unit (21′) which comprises required sanitary and toilet and bathroom equipment and which may be removed there-from and rapidly assembled in-situ, also at least two accommodation units (21, 22, 23, 24, 25) are available, by which each of the accommodation units (21, 22, 23, 24, 25) consists of a bottom panel (210), to which two transversal wall panels (211, 212) optionally equipped by windows (216) and doors (217) as well as two longitudinal wall panels (212, 214) optionally equipped by windows (216) and doors (217) are pivotably attached, over which a ceiling panel (215) is placed.

6. Accommodation assembly according to claim 4, characterized in that within the container (1), which is conceived as a truck container and equipped by telescopic supporting legs (12) operated by means of either hand-driven or electrically operated hydraulic assembly (13), at least three accommodation units (21, 22, 23, 24, 25) are available, by which each of the accommodation units (21, 22, 23, 24, 25) consists of a bottom panel (210), to which two transversal wall panels (211, 212) optionally equipped by windows (216) and doors (217) as well as two longitudinal wall panels (212, 214) optionally equipped by windows (216) and doors (217) are pivotably attached, over which a ceiling panel (215) is placed.

7. Accommodation assembly according to claim 4 or 6, characterized in that within the container (1), which is conceived as a truck container and equipped by telescopic supporting legs (12) operated by means of either hand-driven or electrically operated hydraulic assembly (13), five accommodation units (21, 22, 23, 24, 25) are available, by which each of the accommodation units (21, 22, 23, 24, 25) consists of a bottom panel (210), to which two transversal wall panels (211, 212) optionally equipped by windows (216) and doors (217) as well as two longitudinal wall panels (212, 214) optionally equipped by windows (216) and doors (217) are pivotably attached, over which a ceiling panel (215) is placed.

8. Accommodation assembly according to any of previous claims, comprising a hydraulic assembly (13), by means of which telescopic supporting legs (12) are moved, where said hydraulic assembly (13) is preferably electrically driven, but if desired also hand-operated, and is conceived in such manner that the said legs (12) are movable towards the ground separately and independently each from another, so that moving of each leg (12) is stopped as soon as the contact is established between the leg (12) and the ground, while moving of other legs (12) is continued until all legs (12) either simultaneously or separately are brought into contact with the ground.

9. Accommodation assembly according to any of previous claims, characterized in that the accommodation units (21, 22, 23, 24, 25) and if desired also the sanitary unit (21′) are mobile and transportable by means of land-vehicle (3) or by means of any means for locomotion by water or by appropriate aircraft either simultaneously within a container (1) or separately.

10. Accommodation assembly according to any of previous claims, characterized in that the accommodation units (21, 22, 23, 24, 25) and if desired also the sanitary unit (21′) may be assembled on each desired location either as single units or as combined/complex accommodation units.

11. Accommodation assembly according to any of previous claims, characterized in that the accommodation units (21, 22, 23, 24, 25) and if desired also the sanitary unit (21′) are equipped with necessary installations, especially electric installations, connecting means and switching means, and may be set-up in-situ by pivotable disposition both transversal wall panels (211, 212) optionally equipped by windows (216) and doors (217) as well as of two longitudinal wall panels (212, 214) also optionally equipped by windows (216) and doors (217) away from the bottom panel (210), and by covering them by means of the ceiling panel (215).
